(19) United States
(12) Patent Application Publication
(10) Pub. No.: US 2014/0344003 A1
(43) Pub. Date: Nov. 20, 2014

(54) System and Method for Accelerating Information Technology Organization's Process Definition and Facilitating Process Deployment

(71) Applicant: Tata Consultancy Services Limited, Maharashtra (IN)

(72) Inventors: Nibedita Roy Bardhan, Kolkata (IN); Nidhi Srivastava, Naperville, IL (US); Vanishri Veloo, Karnataka (IN); Vedula Srinivasa Phanindra, Hyderabad (IN); Anju Saxena, London (GB); Iffat Maliha, Maharashtra (IN)

(73) Assignee: Tata Consultancy Services Limited, Maharashtra (IN)

(21) Appl. No.: 14/195,973

(22) Filed: Mar. 4, 2014

(30) Foreign Application Priority Data
May 16, 2013 (IN) 1756/MUM/2013

(51) Int. Cl. G06Q 10/06

(52) U.S. Cl. CPC G06Q 10/06315
USPC 705/7.25

(57) ABSTRACT

Disclosed are a method and a system for accelerating process definition journey and request received pertaining to a project. The method comprises receiving a request from an employee of the plurality of employees. The method further comprises generating automatically a process layout based upon the request. The process layout comprises processes capable of enabling the employee to complete the project by availing step by step guidance covering entire lifecycle of the project complied with CMMI DEV version 1.3 and CMMI SVC version 1.2. Further, the method comprises displaying the processes to the employee on the I/O interface, upon following the processes and its associated enablers thereby ensuring comprehensive and successful completion of the project within budget, schedule, and with quality facilitating process deployment for an Information Technology (IT) organization.

### TECHNICAL FIELD

The present disclosure described herein, in general, relates to information technology (IT) software development and service management, and more particularly to accelerating organization's process definition and facilitating process deployment to execute projects related to software development and service management.

### BACKGROUND

A variety of challenges are faced by an IT organization to meet customer expectations. The challenges may include improving quality of service by optimizing processes, delivery time, changing scope of projects while reducing cost and time involved. The IT organizations need to untangle these challenges effectively and efficiently in order to stay competitive in an ever increasing competitive market of delivering projects related to software development and service management. Further, to resolve these challenges, the IT organization may use an efficient and a well-defined process flow.

Conventional systems are incapable of untangling these challenges because of certain inherent drawbacks such as, obsoleteness, static behavior i.e., not improving with time, non-customer specific, and non-organization specific. Therefore, the conventional systems are of little help in guiding employees when assigned to a new task in a project or when a new employee joins the IT organization. Since, the conventional systems are of little help to the employees in guiding them properly, a lot of time and effort is spent by senior employees in training the employees. Since, the time spent by the senior employees has monetary value; the cost of projects is increased.

Further, the IT organizations also have to ensure that the projects such as, a software development project and/or a service management project, comply with industry quality standards for development and service. The conventional systems are incapable of ensuring that the industry quality standards are complied to and therefore require human intervention to ensure compliance to such industry quality standards, thereby leading to further increase in cost which is undesirable for both the IT organization and the customers of the IT organization.

### SUMMARY

This summary is provided to introduce aspects related to systems and methods for accelerating and facilitating employees of an IT organization in defining processes at organization level for their IT delivery and service management projects. The concepts are further described below in the detailed description. This summary is not intended to identify essential features of the claimed subject matter nor is it intended for use in determining or limiting the scope of the claimed subject matter.

In one implementation a system for facilitating process definition of projects in an Information Technology (IT) organization is disclosed. Facilitating process definition may assist a plurality of employees in completing the projects assigned. The system may comprise a receiving module. The receiving module may be configured to receive a request from an employee pertaining to processes and enablers for a phase. The processes and the enablers may be based upon functions associated with the phase. The phase may be one of a project lifecycle phase and a process lifecycle phase. Further the system according to the implementation may comprise a generation module configured to automatically generate a process layout. The process layout may be based upon the request. The process layout may comprise the processes and the enablers enabling the employee to complete the functions associated with the phase by providing a step by step guidance to the employee using the enablers. Further the system may comprise a display module configured to display the process layout to the employee on the I/O interface.

In another implementation a method for facilitating process definition of projects in an Information Technology (IT) organization is disclosed. The method may assist a plurality of employees in completing the projects assigned to the plurality of employees. The method comprises receiving a request from an employee pertaining to processes and enablers for a phase. The processes and the enablers according to the present implementation may be based upon functions associated with the phase. The phase may be one of a project lifecycle and a process lifecycle. The method may comprise automatic generation of a process layout based upon the request by the employee. The process layout may comprise processes and enablers according. Further a step by step guidance may be facilitated to the employee using the enablers to complete the functions associated with the phase. The process layout may be displayed to the employee on the I/O interface, thereby ensuring comprehensive completion of the project. The method may be performed by a processor.

According to yet another implementation a computer program product having embodied thereon a computer program facilitating process definition of projects in an Information Technology (IT) organization is disclosed. The computer program product according to the present implementation may assist a plurality of employees in completing the projects assigned to the plurality of employees in the Information Technology (IT) organization. The computer program product may be programmed to receive a request from an employee pertaining to processes and enablers for a phase, wherein the processes and the enablers are based upon functions associated with the phase, wherein the phase is one of a project lifecycle phase and a process lifecycle phase. The computer program product may further be programmed to generate automatically a process layout based upon the request, wherein the process layout comprises the processes and the enablers. The computer program product may further be programmed to facilitate a step by step guidance to the employee using enablers to complete functions associated with the phase. The computer program product of the present implementation may be programmed to display a process layout to the employee on the I/O interface, thereby ensuring comprehensive completion of the project.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for facilitating process definition and deployment in an IT organization, in accordance with an embodiment of the present subject matter.

FIG. 2 illustrates the system of the FIG. 1, in accordance with an embodiment of the present subject matter.

FIG. 3 is a flowchart illustrating a method for facilitating process definition and deployment in an IT organization, in accordance with an embodiment of the present subject matter.

FIG. 4 illustrates a SIPOC layout according to an embodiment of the present subject matter.

### DETAILED DESCRIPTION

A system and method for facilitating process deployment and accelerating process definition in an Information Technology is disclosed. The process definitions enables employees of the IT organization in adhering to processes associated with completion of projects in at least one of software development and service management along with defining organization level processes to maintain and enhance the processes. Further, the system may articulate ‘what to do’ and ‘how to do’ for the employees of the IT organization to obtain a consistent and a repeat success in completion of the projects.

In one embodiment of the present subject matter a system with multi-tier architecture as illustrated in Table 1 below is disclosed. The system facilitates process definition thereby assisting a plurality of employees in completing the projects assigned. The project according to the present system may comprise of at least one component, such as lifecycle, phases under each lifecycle, process steps or tasks under each phase, procedures for each task, and enablers, for a start to end project execution.

TABLE 1

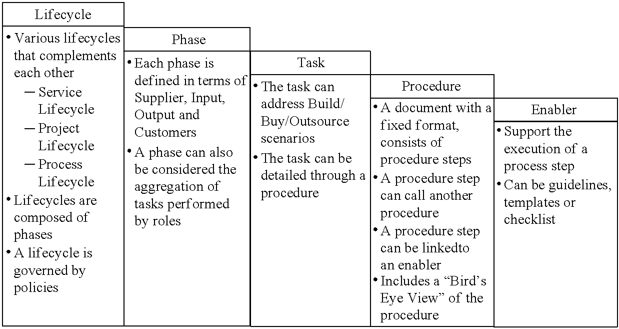

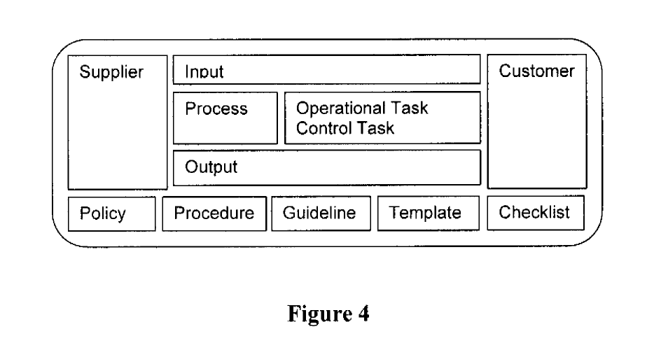

In one embodiment, each phase may be architected in a SIPOC layout. The SIPOC layout may comprise of Supplier (who will provide input), Input, Process (set of process steps or tasks with roles associated), Output, and, Customer (who will be the recipient of the output) as shown in FIG. 4. The process steps or tasks are very important aspect of IT organization. It is indeed important to understand what task a role delivers, and new employee might find it difficult to understand what his/her tasks are. The SIPOC layout may provide a comprehensive process view, wherein the comprehensive view may be aligned with industry and other best practices. The Suppliers, Inputs, Outputs and the Customers may be represented, along the process and may comprise of a sequence of the task. The task may be depicted in four types: Operational—Normal task specific to each phase; Operational (R)—Recurring task occurring throughout the phases; Control (M)—Measurement task for each phase; Control (V)—Verification task for each phase.

The system may to reduce the learning curve for a new associate by enabling them with a role based view to become productive at the earliest. The tasks may be detailed through procedures to elaborate “how” best the task can be executed. The procedures may be structured documents containing a pictorial snapshot of what the procedure is all about along with detailed procedure steps. A procedure step may call another procedure step as applicable. Procedure step may be linked to enablers like templates, or checklists, or guideline or combination thereof. These enablers may support execution of procedure steps with detailed “how” as relevant, making a consistent and quality outcome for repeatable success throughout the project lifecycle across projects.

In other words, to enable with the ‘how’ part of the process execution, various process enablers like templates, checklists, guidelines may be designed as per industry best practices, such as CMMI®, and weaved into the system with multi-tier architecture under process steps or tasks to provide just in time guidance in executing IT projects. Each of these enablers may be designed in such a manner as to enable employee with step by step guidance to understand the process step or task and execute them as intended.

The modular architecture of the framework enables flexibility to plug-n-play with the content of the components as per organization need keeping the industry standards complied leading to easy customization with minimal effort. In addition, the framework has capability to be scaled up easily to embrace other industry models based on organization need.

It may be understood that the multitier architecture of the system may also have a modular architecture. Whereby, every any tier of the multitier architecture can be customized, enabling the framework ‘fit-for-purpose’ based on customer need. The components, like lifecycle, phases, tasks, procedures and enablers, can be customized. For example the customization interface can be as simple as spreadsheets which make adding and dropping of procedures and enablers easy.

The system and method in according to an embodiment may define a RACI Matrix (R—Responsible, A—Accountable, C—Consulted, I—Informed) for all the roles associated with the system. The RACI matrix can also be called a matrix and is based on CMMI®-DEV version 1.3 Maturity Level 3 (ML) and CMMI®-SVC version 1.2 ML 3 and best practices of ITIL V2 and V3. The CMMI®-DEV version 1.3 Maturity Level 3 (ML) refers to the CMMI® standard for development, wherein the version 1.3 was released in year November 2010. Further, the CMMI®-SVC version 1.2 Maturity Level 3 (ML) refers to the CMMI standard for development, wherein the version 1.2 was released in year August 2006.

CMMI® standard for development and services is a model that provides guidance and framework for an organization to improve the processes and increase the level of maturity. The CMMI® model has 3 versions 1.1 released in 2002, 1.2 released in 2006 and 1.3 released in 2010. As per the guidance provided by CMMI each organization has 5 level of maturity. The maturity level ratings are based on the implementation i.e. whether the model is being implemented for development or service. The maturity level for development or services comprises:
Maturity Level 2—Managed:—Configuration Management, Measurement and Analysis, Project Monitoring and Control, Project Planning, Process and Product Quality, Assurance, Requirements Management, and Supplier Agreement Management.
Maturity Level 3—Defined:—Decision Analysis and Resolution, Integrated Project Management, Organizational Process Definition, Organizational Process Focus, Organizational Training, Product Integration, Requirements Development, Risk Management, Technical Solution, Validation, and Verification.
Maturity Level 4—Quantitatively Managed:—Organizational Process Performance, and Quantitative Project Management.
Maturity Level 5—Optimizing:—Causal Analysis and Resolution, and Organizational Performance Management,

In one embodiment of the disclosure the system may enable a filtered view of the processes based on a project scenario and depending on requirement. The employee can choose multiple scenarios, e.g. end to end in-house development, acquiring ‘Commercial off the Shelf’ (COTS) products as per project requirement, outsourcing certain phases or activities.

Further, the definition and execution of the processes as per industry best practices like CMMI© for Development and CMMI for services are disclosed. The system may use an html encoded wiki based navigation views. In one aspect, the modularity of the system may enable organizations to pick and choose relevant information based on their needs which can be aligned to industry best practices and these processes can be easily customized to meet the organization specific need. This way, in organization's process transformation journey, the shorter process definition cycle may result in cost savings with reduced time to market.

While aspects of described system and method for facilitating employees of an IT organization in completing tasks assigned to the employees may be implemented in any number of different computing systems, environments, and/or configuration, the embodiments are described in the context of the following exemplary system.

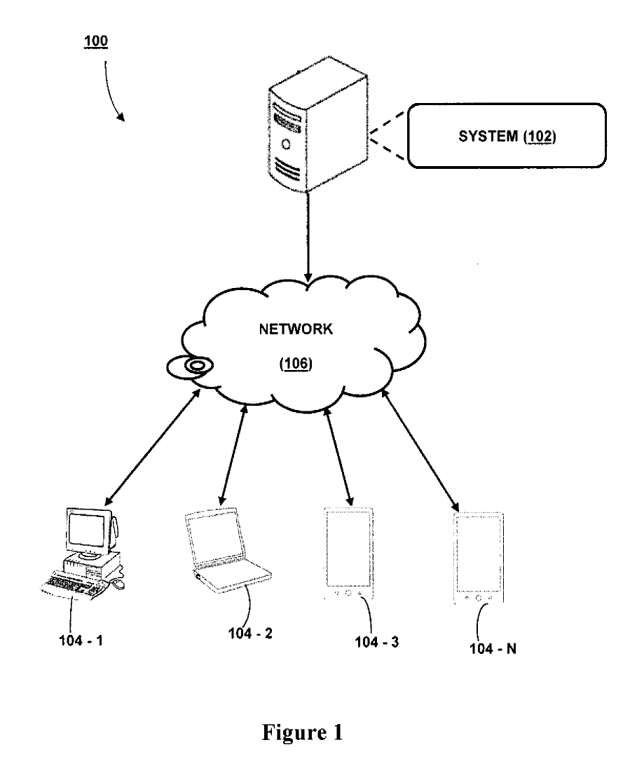

Referring now to FIG. 1, a network implementation 100 of a system 102 for accelerating process definition and facilitating process deployment in an IT organization is illustrated, in accordance with an embodiment of the present subject matter. In one embodiment, the system 102 provides a framework for receiving a request from an employee of a plurality of employees of the IT organization. The request received may pertain to processes and enablers for a phase. The processes and the enablers are based on functions associated with the phase. The phase is one of a project lifecycle phase or a process lifecycle phase. After receiving the request, the system 102 may automatically generate a process layout based upon the request. The process layout enables the employee to complete the functions by providing a step by step guidance to the employee using the enablers. The process layout may comprise the processes, the enablers, tasks and procedures associated with the phase capable of providing guidance. The process layout based on the selection criteria provided in terms of role, phase and project scenario. The process layout may comprise processes capable of enabling the employee to complete the project by providing step wise step guidance to the employee covering entire lifecycle of the project.

The processes may comply with industry quality standards like a CMMI® for Development Maturity Level (ML) 3 version 1.3, and/or a CMMI® for Services for ML 3 version 1.2. The processes may be defined for IT delivery and service management projects. The processes may further comprise of tasks associated under each phase, the procedure for each relevant task, and the enablers for each relevant tasks and procedures.

Subsequent to the generation of the process layout, the system 102 may display the processes in SIPOC layout to the employee, thereby facilitating process definition of projects in the IT organization and ensuring comprehensive completion of the project. The employee may adhere to the processes defined in the process layout, thereby enabling with comprehensive guidance to ensure successful completion of the project assigned to the employee as per industry quality standards.

Although the present subject matter is explained considering that the system 102 is implemented on a server, it may be understood that the system 102 may also be implemented in a variety of computing systems, such as a laptop computer, a desktop computer, a notebook, a workstation, a server, a network server, and the like. It will be understood that the system 102 may be accessed by multiple employees through one or more devices 104-1, 104-2 . . . 104-N, collectively referred to as device(s) 104 hereinafter, or applications residing on the devices 104. Examples of the device 104 may include, but are not limited to, a portable computer, a personal digital assistant, a handheld device, and a workstation. The devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the Internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

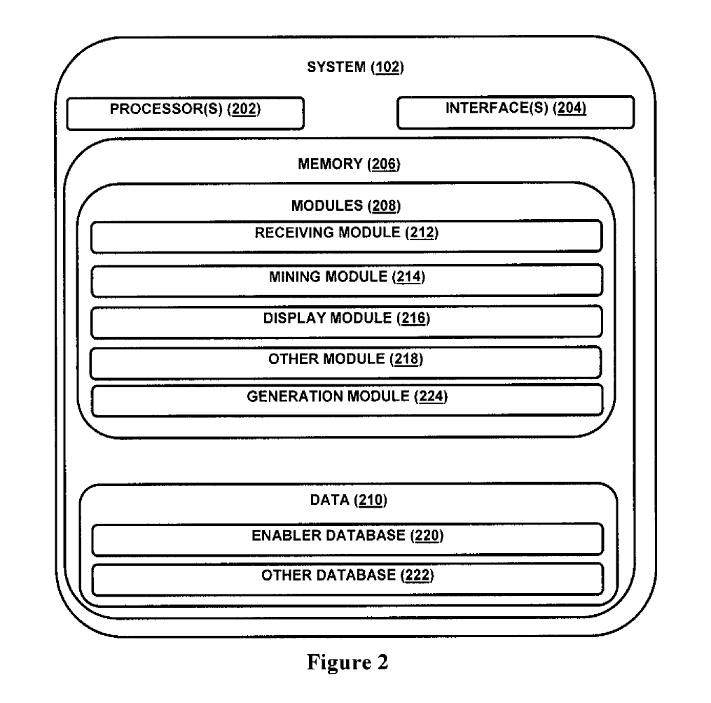

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with an employee directly or through the devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a receiving module 212, a mining module 214, a display module 216, a generation module 224 and other modules 218. The other modules 218 may include programs or coded instructions that supplement applications and functions of the system 102.

The data 210, amongst other things, serves as a repository for storing data processed, received, and generated by one or more of the modules 208. The data 210 may also include an enabler database 220, and other database 222. The other data 222 may include data generated as a result of the execution of one or more modules in the other module 218.

In one implementation, at first, an employee may use the device 104 to access the system 102 via the I/O interface 204. The employee may register themselves on the framework provided by the system 102. The framework may be accessed using the I/O interface 204 in order to use the system 102. After registration, the system 102 may receive a request using the receiving module 212. The request received may pertain to processes and enablers for a phase. The system 102 may be used for defining the processes involved in a project in an IT organization. The processes and the enablers may be based upon functions associated with the phase. The phase is one of a project lifecycle phase or a process lifecycle phase. Further the processes may comply with either of the industry quality standards, a CMMI® for Development Maturity Level (ML) 3 version 1.3, or a CMMI® for Services for a ML 3 version 1.2. The processes may comprise building block, like tasks, the procedure for each relevant task, and enablers for each relevant tasks and procedures, for the phase.

After receiving the request pertaining to the processes and enablers for a phase, the generation module 224 generates a process layout. The process layout may comprise processes capable of enabling the employee to complete the project and enablers providing a step by step guidance to the employee. The process layout may include processes related to a project lifecycle, or a project phase. Examples of the project lifecycle may include waterfall, spiral, agile, rapid prototyping, incremental, and synchronize and stabilize. These are a few lifecycles generally known in the art.

As mentioned above, the process layout may also include processes pertaining to the phases. Examples of the process phase may include project initiation, Requirement, Detail Planning, Design, Build, Testing, Release and Warranty for IT delivery projects. Similarly there are different set of phases for IT service management lifecycle. It may be understood that each project lifecycle may have several phases involved and therefore the employee may specify the phase in the lifecycle for which the processes are to be referred and executed.

The process layout may also include processes pertaining to a role of the employee in the IT organization. The role of employee may be understood as designation of the employee in the IT organization or a responsibility of the employee in the project or a function of the employee in the project.

It may be understood that the processes are appropriately defined by the system 102 based upon the request provided by the employee. For example, if an employee X has specified that the project type is software development; the project lifecycle is waterfall; the project phase is project initiation; and the role of the employee X is project manager, then the generation module 224 may automatically generate the process layout precisely fitting the inputs/request. Further, it may be understood that changing the inputs associated with the project may result in different process layout altogether.

In one embodiment, the processes are mined from the enabler database 220. The enabler database 220 can be a referential repository configured to store processes for entire lifecycle of the project. It may be understood that a lifecycle may include several phases; and each phase may further include several tasks to be performed by various roles in the IT organization. Therefore, the processes are developed for each task, associated with each role, in each phase of a lifecycle. Further, the processes are developed by adopting best practices of the IT industry for completing projects such as, software development projects and service management projects. Since the processes are developed using the best practices, the processes help the employees of the IT organization to comply with industry quality standards such as, CMMI®-DEV version 1.3 (ML) 3 and CMMI®-SVC version 1.2 ML 3.

In one embodiment, each of the phases can be associated with Supplier, Input, Process, Output, and Customer (SIPOC) in the framework. Further, each of the processes in each of the phases further comprises of procedures. The procedures define the workflow and detailed “how” for the task or process step. Moreover, the processes can be viewed as per selected project scenario. The scenarios may be end-to-end in-house development, acquiring ‘Commercial off the Shelf’ (COTS) products, and/or outsourcing certain phases of the project. The scenarios help the employee to understand the variation in the processes. For example, client of the IT organization may wish obtain a payment gateway for a pre-decided cost. In other words, a requirement of the client is to design the payment gateway. Based upon the requirement, the employee may simulate scenarios wherein the employee may view variability in processes and procedures in various scenarios such as, to develop the payment gateway in-house, or to use ready codes (also known as ‘Commercial off the Shelf’ (COTS)) available from various financial institutions, or to outsource certain phases of the project associated with payment gateway. While simulating the scenarios, the system 102 may help the employee to understand certain standard practices in the IT industry.

While generation of the phase wise process layout for the entire lifecycle of the project, the system may mine enablers capable of facilitating the employees in comprehensive understanding and completion of the tasks assigned to the employees. In one embodiment, the mining module 214 may mine the enablers. It may be understood that the enablers are a set of documents capable of guiding the employee to complete the tasks in such a manner such that the tasks completed eventually comply with industry quality standards such as, a CMMI® for development and/or a CMMI® for service. Further, the enablers may also be understood as process assets which completely enable the employee to perform the tasks assigned to the employee in the IT organization by providing step wise step guidance to the employee for completing the tasks assigned. Example of the enablers may include policies, detailed guidelines, templates, checklists, and role definitions, end to end RACI matrix against each key deliverable for each phase.

After mining the enablers, the system 102 displays the process layout to the employee thereby ensuring comprehensive completion of the project. Specifically, the display module 216 provides a filtered view of the process layout based upon the role of the employee in the IT organization. The filtered view may be understood as a role based view.

The comprehensive view may enable the employee to view processes for the entire project lifecycle for junior employees and for him/her. The comprehensive view may also comprise best practices of various models such as CMMI®. The filtered view, one the other hand, may enable the employee to view the processes pertaining to the employee himself/herself. Further, the filtered view may also allow viewing processes based on project scenarios. It may be understood that the employee may select multiple scenarios such as, end-to-end in-house development of the project, acquiring COTS products as per project requirement, and/or outsourcing certain phases of the project.

In one embodiment, the system 102 may also display a RACI matrix. The RACI matrix comprising phase wise deliverables an employee is responsible to create, an employee is accountable, an employee is consulted, and an employee is informed about it, and wherein the matrix complies with at least one of a CMMI® for development and a CMMI® for services models.

Further, according to an embodiment of the present disclosure, the architecture of the framework provided by the system 102 may be customized. The customization enables the framework to be modular thus offering faster adaptability to change with organizational environment. During customization, new phase may be added or existing phase may be deleted from the lifecycle. Further the customization may enable adding and dropping of processes depending upon the requirement of a project. Enabling customization of the lifecycle, phases, tasks, procedures, and enablers of the framework allow the IT organization to adopt a faster approach to complete process definition/refinement thus ensuring cost saving and reduced time to market.

Furthermore, the framework being modular and customizable makes the framework lean and scalable. The use of the framework enables the IT organization to reduce time for defining processes and at the same time comply with the industry quality standards. For example, an IT organization may decide to take a lifecycle approach towards a project while complying with CMMI®-DEV version 1.3 ML 3 that is CMMI® development version 1.2 for ML 3. The framework can be scaled to include other lifecycles like Agile, Rational Unified Process and so on, where in for each lifecycle, phases and their underneath processes can be plugged-in to cater to the requirement.

Therefore, it may be understood that the system 102 ensures adherence to CMMI®-DEV version 1.3 ML 3. It comprises of two life cycles—Project Lifecycle and Process Lifecycle. The Project Lifecycle view provides a partitioned view of the entire life of a software project, through phases that guide the project from inception to conclusion (such as, Ideation to end of Warranty for software development projects). Each phase consists of a set of tasks which may directly contribute into building the software or managing the development or ascertaining the desired level of quality of the end product. Several software processes are defined by certain sets of tasks such as, Testing process and Review process. Each phase ends with tollgate review that acts as a checkpoint for the project to progress to the next phase. Each process step or task is associated with detailed procedure steps and related enablers such as templates, checklists and guidelines.

The process lifecycle view provides a consolidated depiction of the entire life of a process function through phases starting from Foundation, Define, Pilot, Deploy, Assess and Improve on a continuous basis. These process functions are to be built at organization level to support project lifecycle activities. Each process function consists of all six phases with a set of tasks against each of them. These process functions are: Process Engineering function, Process Assurance function, Training function, Measurement function. These functions as a whole enable the organization to define, deploy, assess and refine the organizational process assets through various measurement and training functions.

Phases under each process function can be defined as follows: Foundation—Establish the function; Define—Define the set of processes under the function; Pilot—Pilot the defined processes and refine the process set based on the pilot feedback; Deploy—Deploy the refined set of processes across the organization; Assess—Perform process compliance checks to assess the process functioning; Improve—Improvise the process functioning on a continuous basis and initiate the Define phase again based on the opportunities for improvement. As a whole, both these lifecycle processes enables an organization execute their IT development projects and its peripheral process functions.

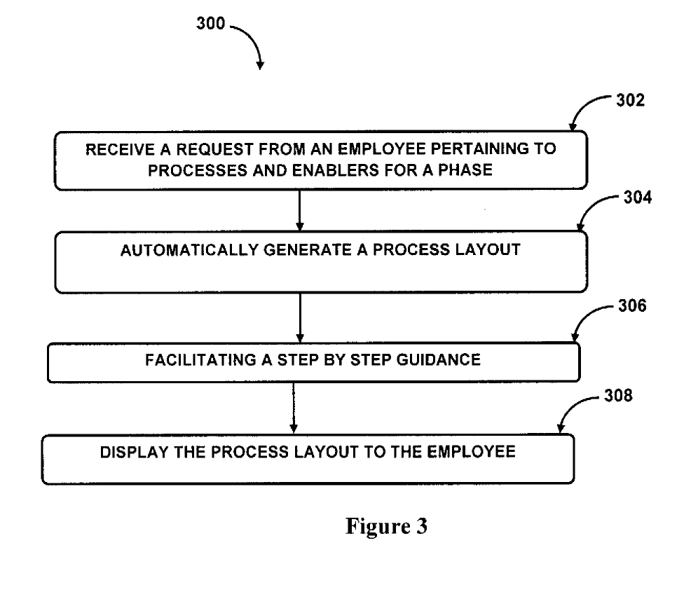

Referring now to FIG. 3, a flowchart illustrating a method for facilitating process definition of projects in an IT organization, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, request from an employee of the plurality of employees may be received. The request may pertain to processes and enablers for a phase and may be received by the receiving module 212. The enablers may be mined from the enabler database by the mining module 214. The enabler's database is a referential repository complying with at least one of CMMI® development standards and CMMI® service standards.

At block 304, process layout is generated automatically based upon the request received from the employee. The process layout is generated using the generation module 224. Further, the process layout may comprise the processes and the enablers. Further tasks and procedures associated with the phase may also be defined during the generation of the process layout. During the generation of the process layout a RACI matrix may also be generated either simultaneously or subsequently as desired. The RACI matrix comprises phase wise deliverables an employee is responsible to create, an employee accountable, an employee consulted, and an employee informed about the phase wise deliverables.

At block 306 step wise step guidance may be displayed to the employee enabling the employee to perform the tasks assigned to the employee in the IT organization.

At block 306, the process layout is displayed or rendered to the employee on the I/O interface (204), thereby ensuring comprehensive completion of the project. Additionally, a filtered view of process layout based upon a role of the employee in the IT organization is displayed. The view is indicative of a filtered view of the tasks and the enablers. In one implementation, the view of the enablers is provided by the display module 216.

Although implementations for methods and systems for accelerating process definition and facilitating process deployment to successfully execute projects in an IT organization have been described in language specific to structural features and/or methods, it is to be understood that the appended claims are not necessarily limited to the specific features or methods described. Rather, the specific features and methods are disclosed as examples of implementations for accelerating process definition and facilitating process deployment to successfully execute projects in an IT organization.

We claim:

1. A system for facilitating process definition of projects in an Information Technology (IT) organization in order to assist a plurality of employees in completing the projects assigned to the plurality of employees in the IT organization, the system comprising:
a processor;
an Input/Output (I/O) interface coupled to the processor; and
a memory coupled to the processor, wherein the processor executes a plurality of modules stored in the memory, the plurality of modules comprising:
a receiving module configured to receive a request from an employee pertaining to processes and enablers for a phase, wherein the processes and the enablers are based upon functions associated with the phase, wherein the phase is one of a project lifecycle phase and a process lifecycle phase;
a generation module configured to automatically generate a process layout based upon the request, wherein the process layout comprises the processes and the enablers capable of enabling the employee to complete the functions associated with the phase by providing a step by step guidance to the employee using the enablers; and
a display module configured to display the process layout to the employee on the I/O interface.

2. The system of claim 1, wherein the process layout further comprises tasks and procedures associated with the phase.

3. The system of claim 1, wherein the processes comply with at least one industry quality standard, wherein the at least one industry quality standard comprises at least one of: a Capability Maturity Model Integration (CMMI) for Development Maturity Level (ML) 3 version 1.3, and a CMMI for Services for ML 3 version 1.2, and wherein the processes are defined for IT delivery and service management projects comprising building blocks, wherein the building blocks further comprise at least one of: a plurality of phases, tasks under each of the plurality of phases, a procedure for each of a plurality of relevant tasks, and the enablers for each of the plurality of relevant tasks and procedures.

4. The system of claim 1, further comprising a mining module configured to mine enablers from an enabler database, wherein the enablers comprise at least one of: policies, detailed guidelines, templates, checklists, and role definitions for the employee, wherein a just-in-time reference for a successful project execution is ensured.

5. The system of claim 4, wherein the enabler database is a referential repository complying with at least one industry quality standard.

6. The system of claim 1, wherein the display module is further configured to display a Responsible-Accountable-Consulted-Informed (RACI) matrix comprising phase wise deliverables, wherein the employee is responsible to create, the employee is accountable, the employee is consulted, and the employee is informed about the phase wise deliverables, and wherein the RACI matrix complies to at least one of: a CMMI for development and a CMMI for services.

7. The system of claim 1, wherein the display module is further configured to display a customized view of the process layout based upon a role of the employee in the IT organization, wherein the customized view is indicative of a filtered view of the processes based on a selection made by the employee on the phase, a role and a scenario.

8. The system of claim 1, wherein the project lifecycle phase has a project lifecycle, wherein the project lifecycle further comprises at least one of: waterfall, spiral, agile, rapid prototyping, incremental, and synchronize and stabilize.

9. The system of claim 1, wherein the process lifecycle phase further comprises at least one of: project initiation, requirement, detail planning, design, build, testing, and release and warranty far an IT delivery project.

10. The system of claim 1, wherein the process lifecycle phase further comprises a process lifecycle view providing a consolidated depiction of an entire life of a plurality of process functions through the phase, wherein the plurality of process functions further comprise: a process engineering function, a process assurance function, a training function, and a measurement function.

11. The system of claim 10, wherein each of the plurality of process functions further comprises six phases, wherein the six phases comprise: foundation, define, pilot, deploy, assess, and improve.

12. A method for facilitating process definition of projects in an Information Technology (IT) organization in order to assist a plurality of employees in completing the projects assigned to the plurality of employees in the IT organization, the method comprising:
receiving a request from an employee pertaining to processes and enablers for a phase, wherein the processes and the enablers are based upon functions associated with the phase, wherein the phase is one of a project lifecycle phase and a process lifecycle phase;
generating automatically a process layout based upon the request, wherein the process layout comprises processes and enablers;
facilitating a step by step guidance to the employee using enablers to complete the functions associated with the phase; and
displaying the process layout to the employee on an I/O interface, thereby ensuring comprehensive completion of the project, wherein at least one of receiving the request, generating the process layout, facilitating the step by step guidance, and displaying the process layout is performed by a processor.

13. The method of claim 12, further comprises defining tasks and procedures associated with the phase.

14. The method of claim 12, further comprising mining enablers from an enabler database, wherein the enablers database is a referential repository complying with at least one of: Capability Maturity Model Integration (CMMI) development standards and CMMI service standards.

15. The method of claim 12, wherein the enablers further comprise at least one of: policies, detailed guidelines, templates, checklists, and role definitions for the employee, wherein a just-in-time reference for a successful project execution is ensured

16. The method of claim 12, further comprises generating a Responsible-Accountable-Consulted-Informed (RACI) matrix comprising phase wise deliverables, wherein the employee is responsible to create, the employee is accountable, the employee consulted, and the employee informed about the phase wise deliverables.

17. The method of claim 12, further comprising displaying a customized view of the process layout based upon a role of the employee in the IT organization, wherein the customized view is indicative of a filtered view of the processes based on a selection made by the employee on the phase, a role and a scenario.

18. A computer program product having embodied thereon a computer program facilitating process definition of projects in an Information Technology (IT) organization in order to assist a plurality of employees in completing the projects assigned to the plurality of employees in the IT organization and the computer program product comprising of:
a program code for receiving a request from an employee pertaining to processes and enablers for a phase, wherein the processes and the enablers are based upon functions associated with the phase, wherein the phase is one of a project lifecycle phase and a process lifecycle phase;
a program code for generating automatically a process layout based upon the request, wherein the process layout comprises processes and enablers;
a program code for facilitating a step by step guidance to the employee using enablers to complete functions associated with the phase; and
a program code for displaying the process layout to the employee on an I/O interface, thereby ensuring comprehensive completion of the project.

19. A computer program of claim 18, further comprising a program code for mining enablers from an enabler database, wherein the enablers database is a referential repository complying with at least one of: Capability Maturity Model Integration (CMMI) development standards and CMMI service standards.

20. The computer program of claim 18, further comprising a program code for displaying a customized view of the process layout based upon a role of the employee in the IT organization, wherein the customized view is indicative of a filtered view of the processes based on a selection made by the employee on the phase, a role and a scenario.
